(19) United States
(12) Patent Application Publication
(10) Pub. No.: US 2026/0332211 A1
(43) Pub. Date: Oct. 22, 2026

(54) METHODS AND APPARATUSES FOR SIMULTANEOUS UPLINK TRANSMISSION OF CONTROL CHANNEL

(71) Applicant: InterDigital Patent Holdings, Inc., Wilmington, DE (US)

(72) Inventors: Loic Canonne-Velasquez, Dorval (CA); Jonghyun Park, Syosset, NY (US); Moon IL Lee, Melville, NY (US); Mohammad Irfan, Chateauguay (CA); Afshin Haghighat, Ile-Bizard (CA)

(73) Assignee: InterDigital Patent Holdings, Inc., Wilmington, DE (US)

(21) Appl. No.: 19/105,920

(22) PCT Filed: Sep. 21, 2023
(86) PCT No.: PCT/US2023/074783

§ 371 Date: Feb. 24, 2025

Related U.S. Application Data
(60) Provisional application No. 63/411,276, filed on Sep. 29, 2022.
(60) Provisional application No. 63/422,588, filed on Nov. 4, 2022.
(60) Provisional application No. 63/445,355, filed on Feb. 14, 2023.

(51) Int. Cl. H04B 7/06; H04W 24/08; H04W 24/10; H04W 72/21

(52) U.S. Cl. CPC H04B 7/0626; H04W 24/08; H04W 24/10; H04W 72/21

(57) ABSTRACT

Transmission on a physical uplink control channel (PUCCH) and/or a physical uplink shared channel (PUSCH) may occur via one or more panels of a wireless transmit/receive unit (WTRU) during the same time slot. The WTRU may be configured to transmit different portions (e.g., Part 1, Part 2) of a Channel State Information (CSI) report via different panels of the WTRU. The WTRU may be configured to transmit Part 1 of the CSI report via a single panel of the WTRU. And the WTRU may be configured to transmit Part 2 of the CSI report via multiple panels of the WTRU in a simultaneous transmission multiple panel (STxMP) mode of operation. The WTRU may be configured to multiplex Part 2 contents over the multiple panels.

### CROSS REFERENCE TO RELATED APPLICATIONS

This application claims the benefit of U.S. provisional patent application Nos. 63/445,355, filed Feb. 14, 2023, 63/422,588, filed Nov. 4, 2022, and 63/411,276, filed Sep. 29, 2022, each of which is incorporated in its entirety herein by reference.

### BACKGROUND

To support physical uplink (UL) control channel (PUCCH) and physical uplink shared channel (PUSCH) transmissions to multiple transmission/reception points (TRPs), a wireless transmit/receive unit (WTRU) performs repeated transmissions. This requires each transmission to be performed in different time slots. This also requires each transmission to be configured with different spatial filters to target the different TRPs.

### SUMMARY

Described herein are methods and apparatuses for performance and configuration of multiple transmissions in the same time slot. In an example embodiment, a wireless transmit/receive unit (WTRU), also referred to as user equipment (UE), may comprise multiple antenna panels (also referred to as panels herein). Transmission on a PUCCH and/or a PUSCH may occur via one or more of the panels during the same single time slot. Transmission on a plurality of channels may occur via one or more of the panels during the same single time slot.

As further described herein, a WTRU may be configured to transmit different portions (e.g., Part 1, Part 2) of a Channel State Information (CSI) report via different panels of the WTRU. For example, a WTRU may be configured to transmit Part 1 of a CSI report via a single panel of the WTRU. And the WTRU may be configured to transmit Part 2 of the CSI report via multiple panels of the WTRU in a simultaneous transmission multiple panel (STxMP) mode of operation. The WTRU may be configured to multiplex Part 2 contents over the multiple panels. As used herein, the term simultaneous also may mean approximately simultaneous or concurrent. Thus, the phrase simultaneous transmissions may mean that the start time of multiple transmissions is the same (within appropriate tolerance), that the transmission times of each transmission of multiple transmissions overlap in time, or any appropriate combination thereof.

An example method for simultaneous uplink transmissions may be performed by a WTRU. The example method may comprise transmitting on a plurality of physical uplink control channels (PUCCHs) in a single time slot, wherein the time of transmission on each PUCCH may overlap. The WTRU may comprise a plurality of antenna panels, wherein the method may comprise receiving a downlink grant comprising a single primary rate interface (PRI) and determining, based on the received downlink grant, to transmit on a PUCCH via one of the plurality of antenna channels. The downlink grant may comprise a transmission time offset parameter. The method may comprise receiving a plurality of downlink grants from a respective plurality of transmission/reception points (TRPs), wherein each downlink grant of the plurality of downlink grants may comprise a respective PRI, and determining, based on the received plurality of downlink grants, to transmit on a respective plurality of PUCCHs via a respective plurality of antenna channels. Each downlink grant of the plurality of downlink grants may comprise a respective transmission time offset parameter. The method may comprise determining to transmit hybrid automatic repeat request acknowledgment (HARQ-ACK) feedback based on a received PRI. The method may comprise prioritizing transmission of channel state information (CSI) reports based on at least one of a number of transmission/reception points (TRPs), an antenna panel identifier (ID), transmission power, overlap in time of PUCCH resources, or overlap in frequency of PUCCH resources. The method may comprise determining a panel transmission scheme to multiplex an uplink control indicator (UCI) on a physical uplink shared channel (PUSCH). The method may comprise determining a per-channel uplink control indicator (UCI) resource.

An example WTRU configured for simultaneous uplink transmissions may comprise a processor and a transceiver. The WTRU may be configured to simultaneously transmit on a plurality of physical uplink control channels (PUCCHs) in a single time slot. The WTRU may comprise a plurality of antenna panels, wherein the WTRU may be configured to receive a downlink grant comprising a single primary rate interface (PRI) and determine, based on the received downlink grant, to transmit on a PUCCH via one of the plurality of antenna channels. The downlink grant may comprise a transmission time offset parameter. The WTRU may be configured to receive a plurality of downlink grants from a respective plurality of transmission/reception points (TRPs), wherein each downlink grant of the plurality of downlink grants comprises a respective PRI, and determine, based on the received plurality of downlink grants, to transmit on a respective plurality of PUCCHs via a respective plurality of antenna channels. Each downlink grant of the plurality of downlink grants may comprise a respective transmission time offset parameter. The WTRU may be configured to determine to transmit hybrid automatic repeat request acknowledgment (HARQ-ACK) feedback based on a received PRI. The WTRU may be configured to prioritize transmission of channel state information (CSI) reports based on at least one of a number of transmission/reception points (TRPs), an antenna panel identifier (ID), transmission power, overlap in time of PUCCH resources, or overlap in frequency of PUCCH resources. The WTRU may be configured to determine a panel transmission scheme to multiplex an uplink control indicator (UCI) on a physical uplink shared channel (PUSCH). The WTRU may be configured to determine a per-channel uplink control indicator (UCI) resource.

An example non-transitory computer-readable storage medium may have executable instructions stored thereon that when executed by a processor, cause the processer to facilitate simultaneous uplink transmissions. When the executable instructions are executed, the processor may be configured to facilitate a WTRU to simultaneously transmit on a plurality of physical uplink control channels (PUCCHs) in a single time slot. The WTRU may comprise a plurality of antenna panels, wherein, when the executable instructions are executed, the processor may be configured to facilitate the WTRU to receive a downlink grant comprising a single primary rate interface (PRI) and determine, based on the received downlink grant, to transmit on a PUCCH via one of the plurality of antenna channels. The downlink grant may comprise a transmission time offset parameter. When the executable instructions are executed, the processor may be configured to facilitate the WTRU to receive a plurality of downlink grants from a respective plurality of transmission/reception points (TRPs), wherein each downlink grant of the plurality of downlink grants comprises a respective PRI, and determine, based on the received plurality of downlink grants, to transmit on a respective plurality of PUCCHs via a respective plurality of antenna channels. Each downlink grant of the plurality of downlink grants may comprise a respective transmission time offset parameter. When the executable instructions are executed, the processor may be configured to facilitate the WTRU to determine to transmit hybrid automatic repeat request acknowledgment (HARQ-ACK) feedback based on a received PRI. When the executable instructions are executed, the processor may be configured to facilitate the WTRU to prioritize transmission of channel state information (CSI) reports based on at least one of a number of transmission/reception points (TRPs), an antenna panel identifier (ID), transmission power, overlap in time of PUCCH resources, or overlap in frequency of PUCCH resources. When the executable instructions are executed, the processor may be configured to facilitate the WTRU to determine a panel transmission scheme to multiplex an uplink control indicator (UCI) on a physical uplink shared channel (PUSCH). When the executable instructions are executed, the processor may be configured to facilitate the WTRU to determine a per-channel uplink control indicator (UCI) resource.

An example WTRU may comprise a transceiver and a processor. The processor may be configured to receive, via the transceiver, configuration information. The configuration information may comprise an indication of a first PUCCH resource, a second PUCCH resource, and an association of one or more respective CSI content types to each of a first CSI part, a second CSI part, the first PUCCH resource, and the second PUCCH resource. The processor may determine a CSI report comprising the first CSI part and the second CSI part, wherein the CSI report is based on the association of the one or more respective CSI content types to the first CSI part and the second CSI part. The processor may transmit, via the transceiver, the first CSI part of the CSI report using the first PUCCH resource at a first time. The processor may transmit, via the transceiver, a first portion of the second CSI part of the CSI report using the first PUCCH resource at a second time, wherein the second time is different than the first time. The processor may transmit, via the transceiver, a second portion of the second CSI part of the CSI report using the second PUCCH resource, wherein transmission of the second portion of the second CSI part of the CSI report overlaps in time with transmission of the first portion of the second CSI part of the CSI report. The first CSI part and the second CSI part may further based on a measurement of one or more reference signals. CSI content types of the first portion and the second portion of the second CSI part of the CSI report may be based on the configured association of CSI content types to the first PUCCH resource and the second PUCCH resource. At least one of the one or more CSI content types may comprise information identifying whether to use a single panel of the WTRU or a multiple panels of the WTRU when determining the CSI report. The transmission of the first CSI part may be via a single panel of the WTRU and the transmission of the second CSI part may be via multiple panels of the WTRU.

An example method performed by a WTRU may comprise receiving configuration information. The configuration information may comprise an indication of a first PUCCH resource, a second PUCCH resource, and an association of one or more respective CSI content types to each of a first CSI part, a second CSI part, the first PUCCH resource, and the second PUCCH resource. The method may comprise determining a CSI report comprising the first CSI part and the second CSI part, wherein the CSI report is based on the association of the one or more respective CSI content types to the first CSI part and the second CSI part. The method may comprise transmitting the first CSI part of the CSI report using the first PUCCH resource at a first time. The method may comprise transmitting a first portion of the second CSI part of the CSI report using the first PUCCH resource at a second time, wherein the second time is different than the first time. The method may comprise transmitting a second portion of the second CSI part of the CSI report using the second PUCCH resource, wherein transmission of the second portion of the second CSI part of the CSI report overlaps in time with transmission of the first portion of the second CSI part of the CSI report. The first CSI part and the second CSI part may further based on a measurement of one or more reference signals. CSI content types of the first portion and the second portion of the second CSI part of the CSI report may be based on the configured association of CSI content types to the first PUCCH resource and the second PUCCH resource. At least one of the one or more CSI content types may comprise information identifying whether to use a single panel of the WTRU or a multiple panels of the WTRU when determining the CSI report. The transmission of the first CSI part may be via a single panel of the WTRU and the transmission of the second CSI part may be via multiple panels of the WTRU.

An example non-transitory computer-readable storage medium may comprise executable instructions for configuring at least one processor to receive configuration information. The configuration information may comprise an indication of a first PUCCH resource, a second PUCCH resource, and an association of one or more respective CSI content types to each of a first CSI part, a second CSI part, the first PUCCH resource, and the second PUCCH resource. The executable instructions may configure the at least one processor to determine a CSI report comprising the first CSI part and the second CSI part, wherein the CSI report is based on the association of the one or more respective CSI content types to the first CSI part and the second CSI part. The executable instructions may configure the at least one processor to transmit the first CSI part of the CSI report using the first PUCCH resource at a first time. The executable instructions may configure the at least one processor to transmit a first portion of the second CSI part of the CSI report using the first PUCCH resource at a second time, wherein the second time is different than the first time. The executable instructions may configure the at least one processor to transmit a second portion of the second CSI part of the CSI report using the second PUCCH resource, wherein transmission of the second portion of the second CSI part of the CSI report overlaps in time with transmission of the first portion of the second CSI part of the CSI report. The first CSI part and the second CSI part may further based on a measurement of one or more reference signals. CSI content types of the first portion and the second portion of the second CSI part of the CSI report may be based on the configured association of CSI content types to the first PUCCH resource and the second PUCCH resource. At least one of the one or more CSI content types may comprise information identifying whether to use a single panel of the WTRU or a multiple panels of the WTRU when determining the CSI report. The transmission of the first CSI part may be via a single panel of the WTRU and the transmission of the second CSI part may be via multiple panels of the WTRU.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Like reference numerals (“ref.” or “refs.”) in the Figures indicate like elements.

FIG. 1A is an example system diagram illustrating an example communications system in which one or more disclosed embodiments may be implemented.

FIG. 1B is an example system diagram illustrating an example wireless transmit/receive unit (WTRU) that may be used within the communications system illustrated in FIG. 1A according to an embodiment.

FIG. 1C is an example system diagram illustrating an example radio access network (RAN) and an example core network (CN) that may be used within the communications system illustrated in FIG. 1A according to an embodiment.

FIG. 1D is an example system diagram illustrating a further example RAN and a further example CN that may be used within the communications system illustrated in FIG. 1A according to an embodiment.

FIG. 2 is an example depiction of simultaneous transmission multiple panel (STxMP) by a wireless transmission/receive unit (WTRU) on multiple antenna array panels to two transmit/receive reference points (TRPs).

FIG. 3 depicts an example of a parameter for STxMP configurable per physical uplink control channel (PUCCH) format.

FIG. 4 depicts an example of a parameter for STxMP configurable per PUCCH resource.

FIG. 5 depicts an example of channel state information (CSI) content mapping to STxMP resources.

### EXAMPLE NETWORKS FOR IMPLEMENTATION OF THE INVENTION

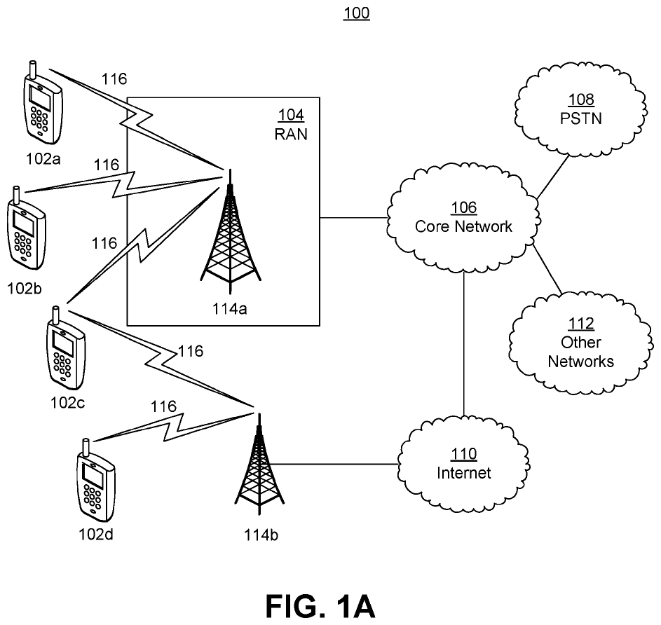

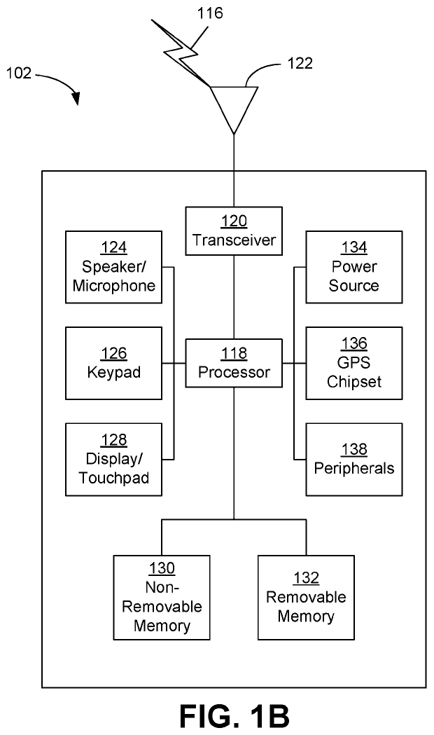

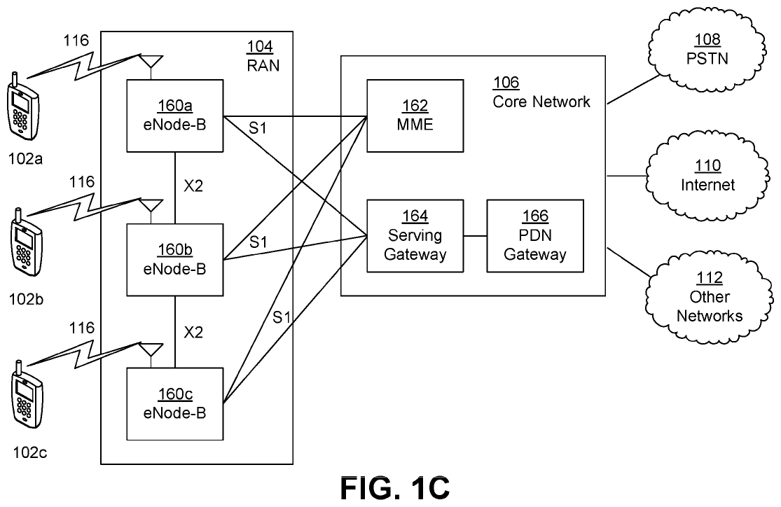

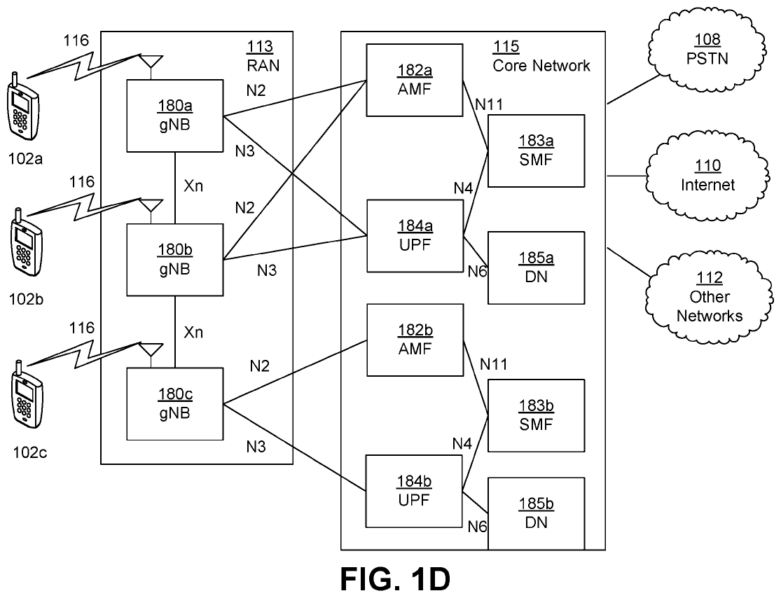

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a next generation Node B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP (third generation partnership project) access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Described herein are methods and apparatuses for supporting and facilitating multiple transmissions in the same single time slot. More specifically, methods and apparatuses are described herein for performance and configuration of simultaneous transmissions in the same time slot of multiple PUCCHs. Currently, PUCCHs cannot be transmitted in simultaneous transmission multiple panel (STxMP) mode of operation. For example, in a single downlink control information (sDCI) scenario, a wireless transmit/receive unit (WTRU) may receive a downlink (DL) grant with a single primary rate interface (PRI) and K1 value (time delay/offset parameter) that indicates to the WTRU one PUCCH resource to use for feedback of hybrid automatic repeat request/acknowledgement (HARQ/ACK) with a time offset of K1. And, in multiple DCI (mDCI) scenarios, the WTRU may receive separate grants from different transmission/reception points (TRPs) where each TRP may indicate a primary rate interface (PRI) and K1 value. To transmit channel state information (CSI) reports, a WTRU may receive a preconfigured PUCCH resource. If multiple CSI reports are scheduled for the same time slot, priority rules may determine which reports are dropped or concatenated into one transmission. The above-described schemes, however, do not support simultaneous transmission in the same time slot of multiple PUCCHs.

Described herein are mechanisms for configuring PUCCH and demodulation reference signal (DM-RS) resources for simultaneous multi-panel transmissions. Also described are mechanisms for a WTRU to determine the mode of operation (e.g., single panel or STxMP), and transmit PUCCH resources (resource selection). Further, the impacts regarding collision rules when more than one PUCCH is scheduled for the same time slot when a WTRU supports STxMP are described.

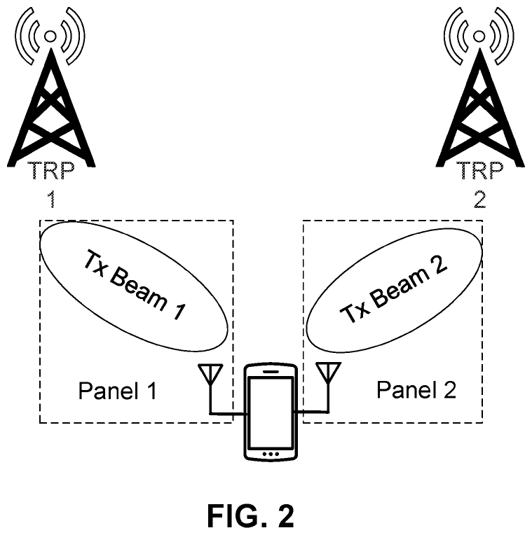

FIG. 2 is an example depiction of STxMP by a WTRU on multiple antenna array panels to two TRPs. STxMP UL is applicable to a wide variety of applications in which WTRUs may be equipped with multiple panels. As depicted in FIG. 2, in STxMP UL, a WTRU may be equipped with two panels (panel 1, panel 2) where each panel is transmitting to its respective TRP (TRP 1, TRP 2). The WTRU may simultaneously transmit in the same time slot on both panels.

As described herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A sign, symbol, or mark of forward slash ‘/’ is to be interpreted as ‘and/or’ unless particularly mentioned otherwise, where for example, ‘A/B’ may imply ‘A and/or B’.

A WTRU may transmit or receive a physical channel or reference signal (RS) according to at least one spatial domain filter. The term “beam” may be used to refer to a spatial domain filter. The WTRU may transmit a physical channel or signal using the same spatial domain filter as the spatial domain filter used for receiving an RS (such as CSI-RS) or a synchronization signal (SS) block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

A WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by a radio resource control (RRC) signal or signaled by medium access control (MAC) control element (CE) or downlink control information (DCI). For example, a WTRU may implicitly transmit physical uplink shared channel (PUSCH) and DM-RS of PUSCH according to the same spatial domain filter a sounding reference signal (SRS) indicated by a SRS resource indicator (SRI) indicated in DCI or configured by RRC. In another example, a spatial relation may be configured by RRC for a SRI or signaled by MAC CE for a PUCCH. Such spatial relation also may be referred to as a “beam indication”.

The WTRU may receive a first (target) downlink channel or signal according to the same spatial domain filter or spatial reception parameter as a second (reference) downlink channel or signal. For example, such association may exist between a physical channel such as physical downlink control channel (PDCCH) or physical downlink shared channel (PDSCH) and its respective DM-RS. When the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication”.

Hereafter, RS may be interchangeably used with one or more of RS resource, RS resource set, RS port and RS port group, but still consistent with this invention. Hereafter, RS may be interchangeably used with one or more of SSB, CSI-RS, SRS, and DM-RS, but still consistent with this invention.

Hereafter, a TRP (e.g., transmission and reception point, transmit-receive point, transmission/reception point) may be interchangeably used with one or more of TP (transmission point), RP (reception point), RRH (radio remote head), DA (distributed antenna), BS (base station), a sector (of a BS), and a cell (e.g., a geographical cell area served by a BS), but still consistent with this invention. Hereafter, Multi-TRP may be interchangeably used with one or more of MTRP, M-TRP, and multiple TRPs, but still consistent with this invention.

A WTRU may be configured with (or may receive configuration of) one or more TRPs to which the WTRU may transmit and/or from which the WTRU may receive. The WTRU may be configured with one or more TRPs for one or more cells. A cell may be a serving cell, secondary cell.

A WTRU may be configured with at least one RS for the purpose of channel measurement. This RS may be denoted as a Channel Measurement Resource (CMR) and may comprise a CSI-RS, synchronization signal and physical broadcast control channel block (SSB), or other downlink RS transmitted from the TRP to a WTRU. A CMR may be configured or associated with a TCI state. A WTRU may be configured with a CMR group which contains CMR indices transmitted from the same TRP. Each group may be identified by a CMR group index (e.g., group 1). A WTRU may be configured with one CMR group per TRP, and the WTRU may receive a linkage between one CMR group index and another CMR group index, or between one RS index from one CMR group and another RS index from another group. A WTRU may determine that linked resources may be configured for coherent joint transmission (C-JT) multiple TRP (mTRP) channel or CSI measurements.

A WTRU may be configured with (or receive configuration of) one or more pathloss (PL) reference groups (e.g., sets) and/or one or more SRS groups, SRS resource indicator (SRI) or SRS resource sets. A PL reference group may correspond to or may be associated with a TRP. A PL reference group may include, identify, correspond to or be associated with one or more TCI states, SRIs, reference signal sets (e.g., CSI-RS set, SRI sets), CORESET index, and or reference signals (e.g., CSI-RS, SSB).

A WTRU may receive a configuration (e.g., any configuration described herein). The configuration may be received from a gNB or TRP. For example, the WTRU may receive configuration of one or more TRPs, one or more PL reference groups and/or one or more SRI sets. A WTRU may implicitly determine an association between a RS set/group and a TRP. For example, if the WTRU is configured with two SRS resource sets, then the WTRU may determine to transmit to TRP1 with SRS in the first resource set, and to TRP2 with SRS in the second resource set. The configuration may be via RRC signaling.

A WTRU may receive an indication of a primary and secondary TRP. When a WTRU is configured with multiple TRPs, it may determine that one of the TRP is the primary or anchor TRP. This designation may be based on a network configuration, or WTRU determination (e.g., received signal quality for one TRP is above all other TRP's received signal quality, or above a threshold).

In the examples and embodiments described herein, TRP, PL reference group, SRI group, and SRI set may be used interchangeably. The terms set and group may be used interchangeably herein. Hereafter, for the brevity of discussion a coherent joint transmission system with two TRPs is considered, however the proposed solutions and processes may equally be employed for cases with more than two TRPs. In this exemplary case, one of the TRP is considered as the primary TRP.

A property of a grant or assignment may comprise at least one of, or any appropriate combination of a frequency allocation, an aspect of time allocation, such as a duration, a priority, a modulation and coding scheme, a transport block size, a number of spatial layers, a number of transport blocks, a TCI state, CSI-RS (CRI) or SRI, wherein a TCI state, CRI, or SRI may be for each WTRU's panel if multiple panels are used for a UL transmission, a number of repetitions, whether the repetition scheme is Type A or Type B, —Whether the grant is a configured grant type 1, type 2 or a dynamic grant, whether the assignment is a dynamic assignment or a semi-persistent scheduling (configured) assignment, a configured grant index or a semi-persistent assignment index, a periodicity of a configured grant or assignment, a channel access priority class (CAPC), any parameter provided in a DCI, by MAC or by RRC for the scheduling the grant or assignment, whether the grant is for single-TRP transmission or multi-TRP transmission, whether the grant is for UL transmission from single WTRU panel (TxSP) or simultaneous UL transmission from multiple WTRU panels (STxMP), or whether the grant is for Coherent Joint Transmission (CJT) or non-coherent joint transmission (NC-JT) transmission.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and the like.

A WTRU may use PUCCH to report control information such as an uplink control indicator (UCI). An UCI may for example carry HARQ-ACK feedback bits associated to a PDSCH transmission scheduled by a grant, in which case the PUCCH resource may be dynamically indicated in the grant using a PUCCH Resource Index (PRI). A WTRU may receive a configuration of multiple PUCCH resources, and the PRI may be mapped to one of the PUCCH resources. An UCI may carry a CSI report associated to a CSI reporting setting and CSI resource settings for measurement. A PUCCH resource may be preconfigured in the CSI reporting configuration.

A WTRU may transmit a DM-RS multiplexed with the PUCCH resource. The network may use the DM-RS to perform channel estimation of the PUCCH resources. A WTRU may generate a DM-RS using a reference sequence which is initialized with a seed. A WTRU may receive a configuration of a scrambling identifier (ID) for the seed as part of the DM-RS-UplinkConfig IE. In addition, a WTRU may receive a cyclic shift index for the DM-RS.

Embodiments related to PUCCH transmission from a WTRU carrying HARQ-ACK feedback bits are discussed below. Embodiments are discussed regarding PUCCH resource configuration and enhancements to support STxMP. A first example is related to a single PUCCH resource configuration to support STxMP. And, a second example is related multiple PUCCH resource configurations, and linking them together to indicate STxMP.

Regarding a single PUCCH resource, one PRI (e.g., codepoint/value) may indicate resources (e.g., PUCH resources) for both panels with panel-specific configuration. To reduce inter-panel interference, different parameters may be assigned by panel. One or more of following may apply.

One PRI (e.g., codepoint/value) may indicate the same time/frequency resource for both panels (where spatial division multiplexing (SDM) case may be prioritized), but may indicate separate DM-RS configurations, separate cyclic shifts (CS), separate scrambling, and/or two (or more, each per panel) active spatial filters, etc. In an example, the WTRU may use a default spatial filter configuration with two beams/panel indices for PUCCH. The WTRU may be indicated (e.g., configured) to use two active spatial relation parameters per PUCCH (e.g., for the PUCCH resource). The WTRU may receive an indication/activation (e.g., via a MAC-CE) of multiple spatial relations per PUCCH (e.g., for the PUCCH resource). The WTRU may transmit the two PUCCH (e.g., over the PUCCH resource) in SDM with different DMRS CSs, scrambling parameters, configurations, and/or the like.

In an example, a PRI (codepoint/value) may be linked to a panel-related identifier, in which one or more of following operations may apply.

In an operation, referred to as Operation 1, a subset of PRI codepoints/values (e.g., among a max 2\hat{ }B number of PRI codepoints/values applicable for a B-bit PRI field configured/used for a DCI) may be configured/activated/used for STxMP. This may provide benefits in terms of achieving a dynamic switching between a single-panel Tx (transmit) and the STxMP through PRI indication (e.g., based on a selected PRI codepoint/value).

In an operation, referred to as Operation 2, a specific (e.g., independent, separated) PRI table for STxMP may be configured/activated/indicated to the WTRU, e.g., for a pre-configured STxMP mode of operation. In an example, the WTRU may be configured with a PRI field (e.g., B=3 bit PRI field, where 2\hat{ }3=8 PRI codepoints/values are available to be selected via a DCI comprising the PRI field), where the WTRU may determine a first interpretation (of the 2\hat{ }B codepoints/values) of the PRI field if not being configured with an STxMP mode, and may determine a second interpretation (of the 2\hat{ }B codepoints/values) of the PRI field if the WTRU is configured with an STxMP mode. The WTRU may apply the new PRI table for STxMP into the PRI field in response to determining to apply the second interpretation based on being configured/activated with the STxMP mode.

In an operation, referred to as Operation 3, for HARQ-ACK, a WTRU may transmit PUCCH in STxMP based on the indicated PRI, if the indicated PRI indicates a PUCCH resource being configure with a new parameter of ‘STxMP’ (enabled), e.g., as a part of the PUCCH resource configuration.

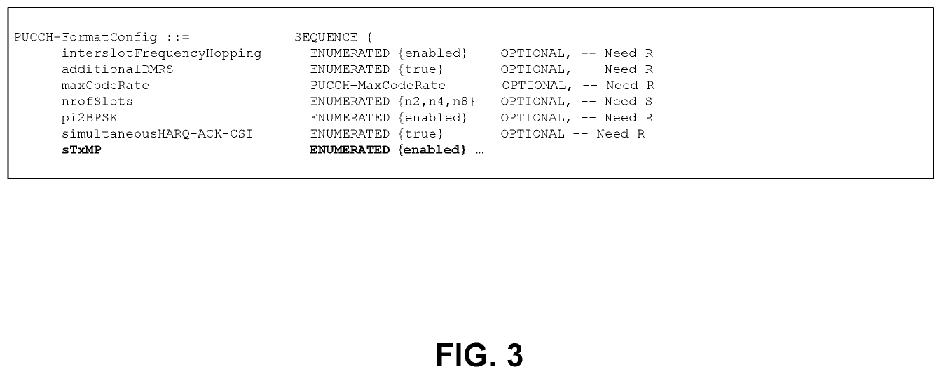

FIG. 3 depicts an example of a parameter for STxMP configurable per physical uplink control channel (PUCCH) format. In an example, the PUCCH resource (for STxMP) may be configured (e.g., via an RRC) comprising (or indicating) a sub-parameter of ‘PUCCH-FormatConfig’ which may include a parameter for enabling the ‘STxMP’. As shown in FIG. 3, a parameter for ‘STxMP’ may be configurable per PUCCH format, where, if a PUCCH resource indicates (e.g., configures, points to) a PUCCH format that has a parameter of sTxMP being enabled, the WTRU may determine that the PUCCH resource is for STxMP (e.g., is to be used for STxMP, at least in terms of PRI codepoint/value interpretation and related WTRU behavior). This may provide benefits in terms of signaling overhead reduction based on the PUCCH-format wise STxMP to be enabled and being used for (e.g., linked to) one or more PUCCH resources for STxMP.

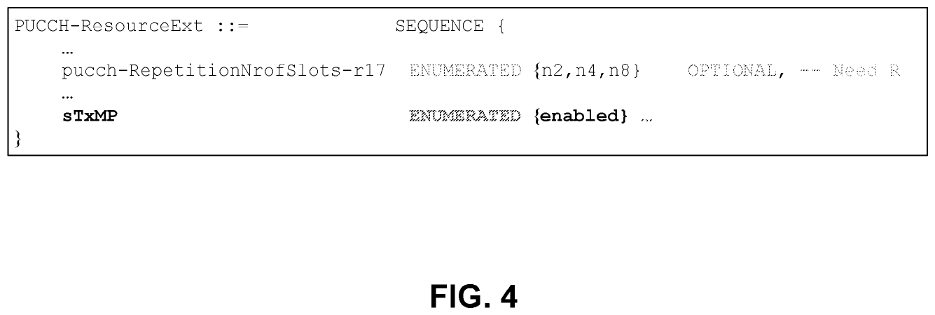

FIG. 4 depicts an example of a parameter for STxMP configurable per PUCCH resource. In an example, the PUCCH resource (for STxMP) may be configured (e.g., via an RRC) comprising (or indicating) a sub-parameter of ‘STxMP’ to be enabled or not. As shown in FIG. 4, a parameter for ‘STxMP’ may be configurable per PUCCH resource, where if a PUCCH resource indicates (e.g., configures) a parameter of sTxMP being enabled, the WTRU may determine that the PUCCH resource is for STxMP (e.g., is to be used for STxMP, at least in terms of PRI codepoint/value interpretation and related WTRU behavior).

If the WTRU determines that a PUCCH transmission (based on STxMP being enabled) is to be performed based on PUCCH repetition (e.g., when a repetition-related parameter of ‘nrofSlots’ is configured, etc.), the WTRU further may identify/determine whether a mapping-pattern parameter (e.g., for time repetition, frequency hopping, beam-domain repetition, and/or panel-domain repetition) also is configured (e.g., enabled, activated, indicated). A first mapping-pattern parameter may indicate that, when PUCCH repetitions are used, mapping patterns for the PUCCH repetitions may include STxMP panel indices (e.g., {1, 2} for rep1, {1,3} for rep2, etc.). Repetition 1 may correspond to a first Tx occasion of the PUCCH repetitions and the repetition 2 may correspond to a second Tx occasion of the PUCCH repetitions. This may provide benefits in terms of improving reliability and robustness of the PUCCH transmission based on applying a different pair of panel indices per Tx occasion for PUCCH repetition, e.g., panel indices {1, 2} being used for PUCCH transmission on the first Tx occasion, and panel indices {1, 3} being used for PUCCH transmission on the second Tx occasion, etc.

The WTRU may determine which power control parameter(s) to use for a PUCCH depending on the panel/TRP being used (e.g., based on a panel index and/or a TRP index). In an example, the WTRU may receive information related to association between power control parameter(s) configured for a panel and the PUCCH transmitted on the same panel.

Regarding multiple PUCCH resources, a WTRU may receive one or multiple PUCCH resource sets (or PUCCH resources), and may receive a configured link between resource sets or resources within sets or resources between sets. Each PUCCH resource or resource set may be associated to a panel and/or TRP. In an example, the WTRU may receive a configuration (or indication) that a first PUCCH resource a from set 1 and a second PUCCH resource from set 2 are linked for STxMP. The WTRU may receive a DCI comprising a PRI field, where the WTRU may determine a value indicated by the PRI field indicates the first PUCCH resource. In response to the determining, the WTRU may identify/determine that the second PUCCH resource is linked to the first PUCCH resource. Based on the identifying, the WTRU may transmit PUCCH in STxMP based on using the first PUCCH resource from the set 1 and the second PUCCH resource from the set 2.

Regarding PUCCH mode of operation, for HARQ-ACK, a WTRU may transmit a single PUCCH resource in one time slot. The WTRU may generate the HARQ-ACK after attempting to decode a PDSCH scheduled by a grant. The WTRU may determine the time slot for PUCCH by receiving K1, a time offset relative to the PDSCH. K1 may be indicated by a bit field in the grant.

In one example, a WTRU may determine to use STxMP to transmit PUCCH. A mode of operation also may be referred to as a WTRU transmission scheme. In single panel mode, a WTRU may transmit one PUCCH in one time slot. In STxMP mode, a WTRU may use more than one panel to transmit one or more PUCCHs, where each PUCCH may be associated to one or multiple TRPs. A WTRU may transmit a PUCCH repetition in STxMP, where one PUCCH content is repeated, and each repetition is mapped to one panel. A WTRU may transmit independent PUCCH contents, where each PUCCH may be mapped to a different panel.

A WTRU may determine the mode of operation as a function of one or more of the following conditions. The WTRU may determine to use the same mode of operation as PDSCH/PDCCH. If a WTRU receives mTRP PDSCH or PDCCH, a WTRU may determine to transmit the PUCCH resources for STxMP. For example, a WTRU may be preconfigured for mTRP PDSCH/PDCCH, and with an associated set of PUCCH resources for STxMP.

A WTRU may be configured with two sets of PUCCH resources (one for single panel, and one for STxMP). A WTRU may receive a grant that dynamically indicates the mode of operation for PDSCH/PDCCH. A WTRU may determine dynamically to switch between the two sets of PUCCH resources as a function of the grant's dynamic indication of PDSCH/PDCCH mode of operation. If a WTRU may receive single TRP (sTRP)/multiple TRP (mTRP) PDSCH/PDCCH, a WTRU may determine the PUCCH resources for single panel/STxMP, respectively.

A WTRU may make a determination based on the mTRP mode of operation of PDCCH/PDSCH (e.g., CJT, NC-JT, repetitions (e.g. only for SFN (single frequency network), TDM, FDM). For example, for CJT-PDSCH, a WTRU may use STxMP for PUCCH, and for NC-JT a WTRU may use single panel PUCCH.

A WTRU may receive a DCI that indicates the PUCCH mode of operation (e.g., single panel or STxMP). A WTRU may determine the mode of operation as a function of the PRI resource configuration. Exemplary PUCCH resource configurations for STxMP are described above. If the grant indicates a PRI resource for STxMP, a WTRU may transmit the PUCCH in STxMP mode. If the grant indicates a PRI resource configured for single panel, a WTRU may transmit on a single panel. A WTRU may receive a MAC-CE that activates/deactivates STxMP mode of operation for PUCCH. The MAC-CE may activate/deactivate PUCCH resources configured for STxMP, or multiple spatial filters per PUCCH resources.

A WTRU may receive two PDSCHs scheduled by their respective DCIs. This is referred to as multi-DCI mode of operation. Each DCI may be sent from a TRP, and a WTRU may receive the PDSCHs partially or non-overlapping. Each DCI may also indicate the timing offset and PUCCH resource to use for HARQ-ACK feedback. After a time offset (K1) relative to each respective PDSCH, a WTRU may transmit the PUCCH containing the HARQ-ACK.

In the intra-cell case, the scheduling may be accomplished independently per TRP so each DCI indicates separate K1 values and PUCCH resources; however, the TRPs may coordinate on the HARQ-ACK feedback. A WTRU may be configured for the HARQ-ACK feedback mode to use separate codebooks. In that case, a WTRU may send separate PUCCH to respective TRPs if they do not overlap in time. If they overlap in time, one of the ACKs is dropped according to priority rules. If a WTRU is configured with a feedback set to joint, and both PUCCH overlap in time, a WTRU may concatenate both ACKs in a single HARQ-ACK codebook, and a WTRU may send both HARQ-ACK to a single TRP using a single PUCCH resource.

Regarding STxMP mode of operation for joint HARQ-ACK feedback, a mode of operation may be utilized when mDCI indicated PUCCHs overlap in time. The network may configure a subset of paired resources for STxMP PUCCH, and a second subset for single panel PUCCH. A WTRU may determine to use the non-paired resources for PUCCH whenever there is no overlap in time, and use paired resources when there is overlap. Two exemplary modes of operation are described herein.

In one example, a WTRU may be configured with separate STxMP HARQ-ACK feedback. If the respective k1 timings of the PDSCHs results in PUCCHs that partially or completely overlap in time, a WTRU may send the separate ACKs per TRP in the same overlapping time slot in STxMP mode of operation.

In another example, a WTRU may be configured with joint STxMP HARQ-ACK feedback. If the respective k1 timings of the PDSCHs results in PUCCHs that completely overlap in time, a WTRU may use the joint HARQ-ACK codebook to generate a single concatenated report, and may transmit a repetition of the report on both panels in STxMP mode. Reports may be generated in any appropriate manner. For example, a WTRU may reuse a joint HARQ-ACK codebook to generate the concatenated report. A WTRU may multiplex reports for more than one panel onto a single report in a single panel, and the joint HARQ-ACK codebook may be generated using the panel indices. For example, first column of the codebook may be for panel 1 ACKs, second column for panel 2 ACKs, etc. If the k1 timings result in partially overlapping PUCCH, a WTRU may transmit one of the PUCCH and drop the second PUCCH according to a priority rule (e.g., primary TRP has higher priority, signal quality per panel, etc.)

Regarding inter-cell embodiments, a WTRU may be indicated to report, send, or transmit UCI (e.g., HARQ-ACK, CSI) using one or more PUCCH resources in a same slot, wherein a mode of operation may be determined based on at least one of number of cells associated with the PUCCH resources, number of DCIs triggering PUCCH transmission, and STxMP transmission/non-STxMP transmission. When a WTRU is indicated or configured to report one or more UCIs in one or more PUCCH resources, the WTRU performs one or more of following based on operation mode.

In a first operation mode (e.g., mDCI intra-cell) in which one or more PUCCH resources are associated with a same cell (e.g., same PCI), a WTRU may determine a PUCCH resource and send one or more UCIs in the PUCCH resource, wherein the WTRU may aggregate one or more UCIs and send them in the same PUCCH resource.

In a second operation mode (e.g., mDCI inter-cell) in which one or more PUCCH resources are associated with a different cell (e.g., different PCI), a WTRU may perform at least one of following schemes.

In an example prioritization scheme (Prioritization scheme 1), the WTRU may prioritize a PUCCH resource within the one or more PUCCH resources based on at least one of following and transmit the prioritized PUCCH resource. Prioritization may be based on UCI contents (e.g., HARQ-ACK, CSI, SR) associated with the PUCCH resource. For example, HARQ-ACK may be higher priority than CSI; SR may be higher priority than HARQ-ACK (e.g., SR>HARQ-ACK>CSI). Prioritization may be based on PCI associated with the PUCCH resource. In an example, a lower number of PCI may be a higher priority. In another example, serving cell ID (servingcellID) may be higher priority than other cell IDs. Prioritization may be based on panel ID associated with the PUCCH resource. For example, a PUCCH resource associated with a panel having lower panel ID may be a higher priority, or vice versa.

In an example STxMP transmission scheme (STxMP transmission scheme 2), the WTRU may transmit simultaneously one or more PUCCH resources indicated/configured across different panels, wherein each PUCCH resource may be associated with a panel (or panel-ID). Individual TA values may be applied for each PUCCH transmission. Power allocation may be different across PUCCH transmissions. A WTRU may determine a scheme (e.g., either prioritization or STxMP) based on total transmission power required for STxMP transmission. For example, if total transmission power for STxMP is higher than a threshold, the WTRU may determine/perform prioritization; otherwise, the WTRU may determine/perform STxMP.

A WTRU may determine a scheme (e.g., either prioritization or STxMP) based on PUCCH resource collision. For example, if one or more PUCCH resources are overlapped in time/frequency, the WTRU may determine/perform prioritization; otherwise, the WTRU may determine/perform STxMP.

When the number of PUCCH resources collisions (e.g., number of consecutive collision) is larger than a threshold, the WTRU may report the event to a network node, such as, for example, a gNB (e.g., serving gNB).

A WTRU may determine a scheme (e.g., either prioritization or STxMP) based on level of overlapping between PUCCH resources in time/frequency. For example, if the overlapping resources between PUCCH resources are larger than a threshold, the WTRU may determine/perform prioritization; otherwise, the WTRU may determine/perform STxMP.

A WTRU may determine a scheme (e.g., either prioritization or STxMP) based on TA difference between PUCCH transmissions. For example, if the TA difference between PUCCH transmissions (e.g., delta_TA) is higher than a threshold, the WTRU may determine/perform prioritization; otherwise, the WTRU may determine/perform STxMP.

In another example, one or more gNBs (or cells) may coordinate to avoid overlapping of PUCCH resources in time/frequency domain. A serving gNB and non-serving gNB (e.g., the gNB involved STxMP) may configure non-overlapping PUCCH resources in time/frequency. PUCCH resources for serving gNB and/or non-serving gNB may be randomized over time. For example, PUCCH resources may be determined based on PCI and time index (e.g., slot number, radio frame number, SFN, etc.). A subset of PUCCH resources for serving gNB and/or non-serving gNB may be determined as active or valid based on a time index. For example, one or more PUCCH resources (or PUCCH resource sets) may be configured and a subset of PUCCH resources (or PUCCH resources) may be valid or activated in a specific time location.

Described below are examples regarding WTRU transmission of PUCCH resources carrying CSI reports in STxMP mode.

CSI prioritization and omission rules may be established. For example, a WTRU may assign a priority value to a CSI report based on the following equation:

Pri_{iCSI}(y,k,c,s)=2N_{cells}Mₛy+N_{cells} Mₛk+MₛC+S,

where the value of y depends on the CSI reporting type (aperiodic, semi-persistent, and periodic) carried on PUCCH or PUSCH, k depends on the signal quality measure (e.g., carrying L1-RSRP or L1-SINR), c is the serving cell index, N_cells is maxNrofServingCells, s is reportConfigID, M_s is the value of the maxNrofCSI-ReportConfigurations. If more than one CSI report is scheduled to be transmitted in the same time index (e.g., slot), a WTRU may transmit the CSI report with the lowest priority value. For example, if an aperiodic and periodic CSI are scheduled for the same slot, the aperiodic CSI report yields a lower priority value, and therefore the WTRU may transmit the aperiodic CSI report. The WTRU may not transmit the periodic CSI.

A priority equation for STxMP mode of operation may be as follows.

Pri_{iCSI}(y,k,c,s,g)=2N_{cells} Mₛy+N_{cells}Mₛk+Mₛc+s+ρ(g)

A value for ρ(g) may be defined or used. The assigned value of ρ(g) may assist/help a WTRU in deciding which CSI report to omit/prioritize over another CSI report on the same panel or different panels. One or more of the following may apply. ρ(g) may be ranged from 0 to 1, wherein the value “ρ(g)=0” may imply high priority to the i_th CSI report on the g_th panel and the value “ρ(g)=1” may imply lowest priority to the i_th CSI report on the g_th panel. Alternatively, ρ(g) may take values from 1 to 10, wherein p (g)=1″ may imply high priority to the i_th CSI report on the g_th panel and the value “ρ(g)=10” may imply lowest priority to the i_th CSI report on the g_th panel. The value of ρ(g) for a CSI report one panel may be independent or co-dependent on the value of ρ(g) for another CSI report on another panel. The value of ρ_{g} for a given CSI report, at a particular panel may be based at least on one of, or any appropriate combination of, channel condition (e.g., SNR, interference, etc.), panel architecture (e.g., number of antennas on the panel, transmit power, panel index, etc.), CSI reporting type/configuration (e.g., codebook/non-codebook, periodic CSI, Aperiodic CSI, semi-persistent CSI, codebook type (Type I, Type II), etc. . . . ), number of CSI reports (e.g., number of CSI reports to be transmitted on one panel, number of CSI reports to be transmitted on another panel, collision between CSI reports on the same panel, collision between CSI reports on different panels, number of CSI reports with collision on each/different panels, etc.), type of traffic (e.g., CSI reports pertaining to high priority traffic, CSI reports pertaining to low priority traffic, etc.), or CSI reporting channel (e.g., PUCCH or PUSCH, etc.).

In an example, a WTRU may assign the same or different values of ρ(g) to a more than one colliding CSI reports on a panel. The value of ρ(g) may be assigned based on the number of overlapped OFDM symbols and/or location of the overlapped OFDM symbols, or one or more of the parameters mentioned above. A WTRU may assign a value of ρ(g) to one or more CSI reports to prioritize them over other colliding/non-colliding CSI reports. In another example, a WTRU may assign the same or different values of ρ(g) to two or more colliding CSI reports on both panels. In an example, a WTRU may assign ρ(g) to two or more colliding CSI reports based on the panel ID to prioritize CSI reports configured on one panel over another panel. In an example, a WTRU may assign small enough value of ρ(g) to prioritize a CSI report configured on PUCCH over another high priority CSI report configured on PUSCH.

In another example, on each panel, a WTRU may sort CSI reports based on its priority level and omit/prioritize some reports over another. A WTRU may also sort all CSI reports on all panels and map the first high priority CSI report to one panel and the second high priority CSI report to another panel. In an example, for two panels, a WTRU may collect all CSI reports from both panels and sort them based on their priority level. Then, a WTRU may map the first high priority CSI report to one panel and the second high priority CSI report to the second panel, the third high priority CSI report to the first panel, and so on. In an alternative example, for two panels, with panel_1 as high priority panel as compared to panel_2, a WTRU may collect all CSI reports from both panels and sort them based on their corresponding priority level. A WTRU may map the first N high priority CSI reports to panel_1 and the remaining CSI reports to panel_2. In another example, a WTRU may assign ρ(g) based on the configured PUCCH or PUSCH resources. A WTRU may assign a smaller value of ρ(g) to one or more CSI reports configured on PUCCH and a higher value of ρ(g) to one or more CSI reports configured on PUSCH, so that one or more CSI reports configured on PUCCH has a higher priority as compared to CSI reports configured on PUSCH. In an example, a WTRU may assign ρ(g) to all CSI reports configured on PUCCH so that all CSI report configured on PUCCH are prioritized over all CSI reports configured on PUSCH.

If two CSI reports have the same priority, and are scheduled to be transmitted on the same panel, a WTRU may determine to transmit, based on a condition, a first CSI report on a first panel, and a second CSI report in the second panel in the same time slot in STxMP mode. If the condition is not met, a WTRU may transmit one of the CSI report in a single panel and may omit transmission of the second CSI report.

A condition for STxMP may be based on RSRP difference between panels above a threshold: if both panels have similar RSRP, a WTRU may use both panels for STxMP. A condition for STxMP may be based on panel activation status. If both panels are activated, a WTRU may use both. A condition for STxMP may be based on time to activate. If a panel is not active, but the time to activate is less than a threshold (e.g., less than the scheduled PUCCH time slot), a WTRU may use both panels for STxMP.

Periodic CSI (P-CSI) STxMP resource configuration and mode determination are described. In P-CSI reporting mode, a WTRU may be preconfigured with PUCCH resources. A WTRU may transmit on the given PUCCH resources at fixed interval times (e.g., every t seconds). A WTRU may be given a single PUCCH resource for a single panel transmission.

A P-CSI reporting configuration may be preconfigured with an STxMP mode of operation. For example, one P-CSI report configuration may be configured with PUCCH resources for STxMP, and an explicit mode of operation flag. If a WTRU is scheduled to transmit this CSI report, a WTRU may use STxMP, where both panels transmit the same CSI report contents as repetitions. Alternatively, an STxMP mode may be implicitly determined as a function of the codebook type (e.g., Type I or Type II). For example, if a WTRU is scheduled to transmit P-CSI for a Type I codebook, a WTRU may transmits with STxMP, and for Type II always in single panel.

In an example regarding P-CSI with dynamic switching of STxMP PUCCH resource configuration, a WTRU may receive a CSI reporting configuration for P-CSI which may include two sets of PUCCH resources, where one set may be used for single panel transmission, and a second set of resources may be used together with the first set to enable STxMP. A WTRU may determine to use both sets of resources, and may transmit the PUCCH on both panels simultaneously. For example, based on a priority equation, two P-CSI reports may be configured to be transmitted in at least one slot (e.g., first report has periodicity t seconds, and second report has periodicity 2t seconds). In the slot where the reports overlap, a WTRU may use the configured resources for STxMP to transmit PUCCH on their respective panels. In the slots where the reports don't overlap, a WTRU may use the configured resources for single panel and transmit on only one panel.

In an example regarding a time slot based pattern of STxMP and a single panel, a WTRU may receive a time-based pattern of modes of operation, and a WTRU may determine the mode of operation per slot to transmit P-CSI reports. The time-based pattern may be received in the CSI reporting configuration, or indicated (e.g., through a DCI such as a Slot Format Index (SFI)). For example, a WTRU may receive a pattern where slots 1 to 5 indicate single panel transmission, and slots 6 to 10 indicate STxMP. Then, if the WTRU is scheduled to transmit a CSI report in slots 1 to 5, the WTRU may transmit the P-CSI report in a single panel. If the WTRU is scheduled to transmit a CSI report in slots 6-10, the WTRU may transmit the P-CSI report on both panels (e.g., WTRU transmits a repetition of the same CSI report, where repetition 1 is sent on panel 1 and repetition 2 is sent on panel 2 in STxMP).

In Semi-Persistent CSI (SP-CSI) reporting mode, the network may activate and deactivate the configured SP-CSI PUCCH reporting by sending a PUCCH activation/deactivation MAC-CE. When activated, a WTRU may send CSI reports according to the SP-CSI configuration until the WTRU may receive a deactivation command. The SP-CSI MAC-CE contains the serving cell ID, the BWP ID, a bit to denote the activation/deactivation status per SP-CSI reporting configuration (4 total), and reserved bits (4 total).

In MAC-CE based indication of SP-CSI STxMP mode of operation, each reserved bit may be reused to indicate the STxMP mode of operation per SP-CSI reporting configuration. For example, a WTRU may receive a MAC-CE activating reporting configuration 1, and an additional bit=1 to indicate that the SP-CSI is activated for STxMP, or bit=0 to indicate that the SP-CSI is activated for single panel. The SP-CSI configuration may include two sets of resources, one for single panel and another for STxMP. A WTRU may determine to use the set associated to the activated mode of operation. A WTRU may transmit SP-CSI in STxMP mode if the activation bit=1, and single panel if the activation bit=0.

Regarding MAC-CE based activation of multiple spatial filters per PUCCH resource, a WTRU may be configured with an SP-CSI with one set of PUCCH resource, and two spatial filters per PUCCH resource. A WTRU may determine the number of spatial filters activated per PUCCH resource as a function of the activation bit received in the MAC-CE. If the activation bit=1, a WTRU may determine to transmit using both spatial filters per PUCCH resource, and if the activation bit=0, a WTRU may determine to transmit using one of the spatial filters (e.g., the one with the lowest index) per PUCCH resource. This MAC-CE may be used for PUCCH resources of any type of reporting. The activating MAC-CE may include a time-based pattern for activation. Similar to the P-CSI case, the MAC-CE may indicate the time slots used for single panel and others for STxMP. A WTRU may transmit SP-CSI reports with a mode of operation as a function of the slot index.

A WTRU may be configured for single CSI content multiplexing over simultaneous PUCCH transmissions. A WTRU may have a single CSI reporting configuration (CSI report #n) where a WTRU reports one or more (e.g., multiple) CSIs assuming different transmission hypothesis such as sTRP, and/or mTRP hypothesis (e.g., Coherent Joint Transmission (CJT) and/or Non-Coherent Joint Transmission (NCJT). This may be specified as CSI reporting Mode 1.

A hypothesis may represent a transmission mode from the network to the WTRU. For example, one hypothesis may be a single TRP transmission from TRP1. Another hypothesis may include a mTRP transmission from TRP1 and TRP2. A WTRU may generate one set of CSI components (e.g., CQI, RI, PMI) per hypothesis. For sTRP1 hypothesis, a WTRU may report one CQI/RI/PMI corresponding to the CSI measurement on a reference signal (RS) from TRP1. For mTRP NC-JT, a WTRU may report one CQI/RI/PMI per TRP corresponding to CSI measurements on RSs from TRP1 and TRP2, respectively. For mTRP C-JT, a WTRU may report one CQI/RI, and/or one or multiple PMIs, where each PMI may be associated to a TRP.

Each hypothesis may be configured in the CSI report as a pair between one or more CMRs and one IMR. The WTRU may receive a CMR to measure the channel, and/or an IMR to measure the interference (e.g., intra-cell and/or inter-cell). The gNB may configure the REs for CMRs and/or IMRs such that a WTRU may measure the SINR assuming one of the hypothesis. For example, a sTRP hypothesis from TRP1 may include 1 CMR and/or IMR configured from TRP1 without interference from TRP2. A mTRP hypothesis may include 1 CMR from TRP1, 1 CMR from TRP2, and/or one IMR considering inter-TRP interference.

A WTRU may generate a CSI report which may have resource overhead (e.g., PUCCH and/or PUSCH resources). For example, a WTRU may be configured with multi-antenna port Type-I or Type-II codebook CSI reports which include the WTRU to feedback CQI/RI/PMI for multiple layers and/or subbands, and/or for multiple TRP hypotheses. Many feedback bits may include the WTRU to send a PUCCH and/or PUSCH with one or more (e.g., all) quantities indicated by the CSI reporting configuration such as coefficients, amplitudes, and/or cophasing values. In NR, a WTRU may be configured to report CSI in two parts (e.g., Part 1 and/or Part 2) that are sent one after the other (e.g., sent in different time instances), where Part 1 is of fixed size and/or includes a subset of the CSI contents, and/or an indication of the contents and/or size of Part 2. Part 2 may include another subset of CSI contents according to Part 1's indication. To reduce overhead, a WTRU may drop one or more (e.g., some) of the contents (e.g., hypothesis and/or subbands) from the CSI report according to a priority rule. However, dropping one or more contents may results in an incomplete CSI report. A WTRU may have to wait until a next CSI reporting occasion to include the missing parts.

The WTRU may transmit Part 2 of CSI in STxMP mode of operation. In examples, to avoid dropping one or more (e.g., some) contents from Part 2, a WTRU may send Part 1 of the CSI report with single panel, and a WTRU may send Part 2 of the CSI report with STxMP where different CSI contents are multiplexed onto different panels. Instead of dropping some contents of Part 2, the WTRU may multiplex CSI over two PUSCH and/or PUCCH transmissions that are in STxMP mode of operation. For example, a WTRU may be configured with a first PUCCH resource, and/or may transmit Part 1 of the CSI report on the first PUCCH resource. A WTRU may be configured with a pair of PUCCH resources to transmit Part 2 of the CSI report over the pair in STxMP.

A WTRU may transmit Part 2 in two different modes, which may be in repetition mode and/or multiplexing mode. In repetition mode, Part 2 content may be repeated over both PUCCH resources. In multiplexing mode, WTRU may split the WTRU's CSI measurements into two, and/or each part may be transmitted in a PUCCH resource, where both PUCCH resources are transmitted in STxMP. Part 2 may include one or more (e.g., all) content transmitted over both panels.

In examples, a WTRU may receive a bitfield to indicate whether the Part 2 of the CSI report is used for STxMP repetitions, and/or for STxMP multiplexing. The bitfield may be configured in Part 1 of the CSI report, and/or may be indicated dynamically in a DCI when triggering an AP-CSI, and/or activating a SP-CSI report. For example, the bitfield may indicate 0 if the STxMP PUCCH resource 1 and/or PUCCH resource 2 include the same content. CSI Part 2 may therefore be repeated and/or the WTRU may transmit STxMP PUCCH to enhance the reliability of the Part 2 transmission. Additionally, or alternatively, the bitfield may indicate 1 if the STxMP PUCCH resource 1 and/or PUCCH resource 2 includes different contents. In this case, the WTRU may transmit STxMP PUCCH with more payload capacity since two panels are used with different contents.

In examples, the bitfield may be used to switch between different panel modes of operation for Part 2. If the bit is 0, then Part 2 may be transmitted using single panel resources; if the bit is 1, then Part 2 may be transmitted using STxMP resources.

Regarding CSI content splitting rules for Part 2, a WTRU also may receive a rule for splitting the CSI reporting contents to different panels. A mapping rule may be configured to determine which part(s) of the CSI may be associated to each STxMP PUCCH resource. Table 1 shows an exemplary Part 1 CSI fields for a CSI report configuration #n with a preconfigured rule to split CSI conditioned on CRIs into two PUCCH resources if STxMP is activated. One new bit (e.g., Stxmp_Part2) may include in the CSI field for Part 1. If the bit is 0, the WTRU may transmit Part 2 on a single panel. If the bit is 1, the WTRU may transmit Part 2 with STxMP, and the CSI conditioned on CRI=0 is transmitted on a first panel, and the CSI conditioned on CRI=1 is transmitted on a second panel.

TABLE 1
Part 1 and Part 2 CSI with per panel content splitting

| CSI report number | CSI fields (Part 1) |
|---|---|
| #n | Stxmp_Part2 = 1 |
| | CRI = 0 |
| | . . . |
| | CRI = 1 |
| | . . . |

| CSI report | | |
|---|---|---|
| number | CSI fields (Part 2) | |
| #n | Panel 1 (PUCCH resource 1) | Panel 2 (PUCCH resource 2) |
| | PMI information of all SBs | PMI information of all SBs |
| | conditioned on CRI = 0 | conditioned on CRI = 1 |

Additionally, or alternatively, a bit may be included in Part 1 to indicate a splitting rule for Part 2. This additional bit in Part 1 may determine different ordering/structure of Part 2 according to a predefined mapping rule. The subset mapping rule may be based on one of the following alternatives. The subset mapping rule may be based on the subband indices. For example, a WTRU may include the CSI contents for even subbands in PUCCH resource 1, and/or for odd subbands in PUCCH resource 2. CSI Part 2 may therefore be transmitted by using STxMP PUCCH to multiplex additional CSI. The subset mapping rule may be based on the reporting hypothesis. For example, a WTRU may be configured with a CSI reporting setting with multiple sTRP hypothesis. In Part 2, a WTRU may report the CSI for sTRP1 hypothesis on a first PUCCH resource, and/or the CSI for sTRP2 hypothesis on a second PUCCH resource in STxMP, where the WTRU may determine the PUCCH resources per panel as a function of the bitfield in Part 1. The subset mapping rule may be based on the CW index. A WTRU may report all CSI related to one codeword (CW) in a first PUCCH resource, and/or one or more (e.g., all) CSI related to a second CW in a second PUCCH resource in STxMP. The subset mapping rule may be based on the CRI. For example, a WTRU may calculate multiple CSI where a first CSI is conditioned on CRI1, and/or a second CSI is conditioned on CRI2. A WTRU may receive an association between CRIs and PUCCH resources. A WTRU may transmit CSI conditioned on CRI1 in a first PUCCH resource, and/or CSI conditioned on CRI2 in a second PUCCH resource in STxMP.

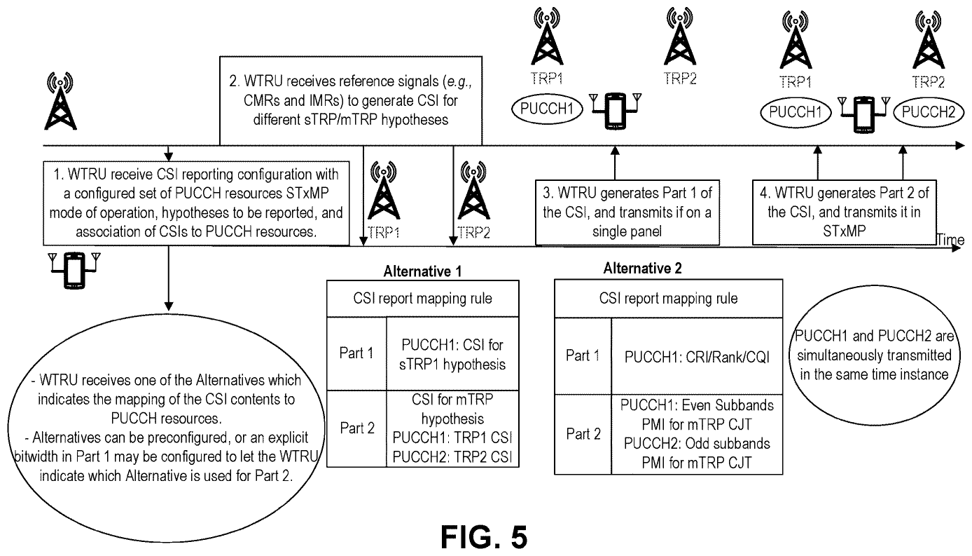

FIG. 5 depicts an example of channel state information (CSI) content mapping to STxMP resources. As depicted in FIG. 5, multiple mapping rules may be preconfigured (2), and a WTRU may use the STxMP_Part2 bit to select amongst one of the alternatives. CSI contents may be split into parts, and into PUCCH1 and PUCCH2 according to hypothesis, or subband indices. The WTRU may measure the CSI using the reference signals transmitted per TRP. The WTRU may generate the CSI content, and may multiplex Part 1 of the CSI onto the associated PUCCH resource and may transmit on a single panel. The WTRU may multiplex Part 2 of the CSI onto the pair of PUCCH resources, and the WTRU may transmit both PUCCH resources simultaneously.

Regarding reduced overhead mTRP PUCCH HARQ-ACK, in a multi-DCI PDSCH transmission, a WTRU may be configured with one or more PUCCH resource sets for HARQ feedback transmission associated to the received PDSCHs. In an example, a WTRU may be configured with more than one PUCCH resource sets where each resource set may be associated with a different panel and/or TRP. For example, a WTRU may be configured with up to 8 PUCCH resource sets where a first 4 sets may be associated with a first panel and/or a TRP, and a second 4 sets may be associated with a second panel and/or a TRP.

In another example, a WTRU may be configured with more than one PUCCH resource sets where a first resource set may be used for transmission of ACK or NACK, and a second resource set may be used for transmission of joint ACK and/or NACK.

In another example, a WTRU may be configured with only one PUCCH resource set where a first set of resources may be designated for transmission of ACK/NACK, and a second set of resources may be designated for transmission of joint ACK and/or NACK. The designation of resources may be by configuration, order of resource indexing, etc.

In another example, a WTRU may be configured with a single PUCCH resource set where each PUCCH resource may have one or more of the following features. Each PUCCH resource may have at least two spatial relation information where each spatial relation may be associated with a different panel and/or TRP. PUCCH resources may be indexed and grouped such that each group may be associated with a different panel and/or TRP.

When a WTRU receives more than one scheduled PDSCH, the WTRU may determine the number of ACKs/NACKs according to the success of the PDSCH decoding success. A WTRU may receive more than one PDSCH payload where its HARQ feedback timings relative to the timing of the received PDSCHs are indicated by more than one scheduling DCIs. The received PDSCHs may or may not be received simultaneously. When a WTRU is scheduled with two PDSCHs, a WTRU may attempt to decode the received payloads and transmit the corresponding ACKs/NACKs accordingly. According to the outcome of the decoding of the received PDSCHs, one of the following cases may occur.
Case 1. NACK (PDSCH1), NACK (PDSCH2)
Case 2. NACK (PDSCH1), ACK (PDSCH2)
Case 3. NACK (PDSCH1), ACK (PDSCH2)
Case 4. ACK (PDSCH1), ACK (PDSCH2)

One or more of the following may be employed by a WTRU for ACK and/or NACK indication. For cases 2 and 3, a WTRU may continue to use the received PRI in the received scheduling DCI to determine the corresponding PUCCH resources for transmission of separate ACK/NACK. For cases 1 and 2, by employing one or more of the following, a WTRU may transmit a joint ACK and/or NACK, e.g., a single bit. A WTRU may be configured with at least one dedicated PUCCH resource for joint transmission of ACKs and/or NACKs. For HARQ transmission, a WTRU may use the indicated HARQ timing information of a designated PDSCH in the scheduling PDCCH, where the designated PDSCH may be defined at least by one of the following: (1) The PDSCH that corresponds to a pre-configured panel or TRP, e.g., first panel or first TRP′; (2) The PDSCH received with a specific timing, e.g., the first received PDSCH, the first scheduled PDSCH, etc.; or (3) The PDSCH that is associated with the link with a higher signal quality, e.g., higher RSRP′.

A WTRU may use one dedicated PUCCH resource for joint transmission of ACKs, and another dedicated PUCCH resource for joint transmission of NACKs. For transmission of a joint ACK/NACK, a panel and/or a TRP may be selected by use of one or following methods. A WTRU may use the panel and/or TRP that is associated with a stronger signal quality measurement, e.g., higher RSRP. A WTRU may randomly select one of the panel and/or TRP. A WTRU may select both panel and/or TRP link, e.g., simultaneous transmission on both panels. If one dedicated PUCCH resource per PDSCH, e.g., per panel and/or TRP is configured, a WTRU may use the PUCCH resources associated with the link with a higher signal quality measurement, e.g., higher RSRP. A WTRU may randomly use one of the PUCCH resources. A WTRU may use the earliest PUCCH resources according to the HARQ timing indicated by the scheduling PDCCHs.

An uplink control indication (UCI) may be multiplexed on a PUSCH via multiple antenna panels. For example, if a WTRU determines to transmit an UCI carrying CSI or HARQ in a time slot where a PUSCH is also scheduled for transmission, the WTRU may multiplex the UCI onto the PUSCH transmission. In NR, a WTRU determines the number of resources available for the UCI as a function of a configured value, the beta factor. This beta factor defines the fraction of PUSCH resources that are allocated for the UCI instead of uplink-shared channel (UL-SCH) data. The beta factor may be signaled through a grant scheduling the PUSCH transmission, or may be preconfigured. The WTRU may receive, as part of the PUSCH configuration, an indicator on whether the beta factor is dynamically indicated or preconfigured. Described herein are mechanisms for applying the beta factor, and determining which panels to use.

In an example embodiment, a WTRU may determine a panel transmission scheme to multiplex the UCI onto PUSCH. The WTRU may receive a beta factor, and may determine to multiplex the UCI on one of the available panels based on a rule. The WTRU may use the beta factor on the determined panel.

In example embodiments, a WTRU may determine if UCI multiplexing on PUSCH is possible for STxMP based on various factors. For example, a WTRU may determine if UCI multiplexing on PUSCH is possible for STxMP based on an explicit indication in a grant indicating that the WTRU is to transmit the UCI multiplexed in STxMP. The UL-SCH indicator may be a one bit field in the DCI which indicates if a PUSCH carries only UCI. The UL-SCH indicator may be expanded to two bits, where each bit is associated with a panel. A new bit field in a DCI may be defined to indicate to transmit the UCI in single panel with panel index selection, STxMP with repetition or partitioning.

A WTRU may determine if UCI multiplexing on PUSCH is possible for STxMP based on the WTRU receiving a MAC-CE to activate/deactivate the UCI multiplexing in STxMP. A WTRU may determine if UCI multiplexing on PUSCH is possible for STxMP based on signal qualities of multiple panels (e.g., two panels) being above threshold, wherein a WTRU may multiplex the UCI over the multiple panels. In an example embodiment, if multiple panels are above a threshold, and if the signal quality difference between panels is above a threshold, then a WTRU may not multiplex the UCI in STxMP (e.g., only multiplex and transmit on the strongest panel).

A WTRU may determine to transmit the UCI on a single or multiple panels (e.g., two panels) as a function of the UCI payload size. The WTRU may receive a threshold number of bits, and the WTRU may determine to multiplex the UCI onto multiple panels if the UCI payload size is above the threshold, and the WTRU may determine to multiplex the UCI onto a single panel if the UCI payload size is below the threshold.

A WTRU may determine to transmit the UCI on multiple panels (e.g., two panels) as a function of the PUSCH mode of operation. For example, if a WTRU receives an indication to transmit the PUSCH in STxMP (e.g., SRS resource set indicator dynamic switching), the WTRU may determine that the UCI may be transmitted also in STxMP. Alternatively, a WTRU may transmit the UCI in STxMP as a function of one type of STxMP mode of operation (e.g., if SFN is configured and not SDM, or vice-versa).

A WTRU may transmit the UCI on both panels, where the WTRU may transmit a repetition of the UCI in STxMP. For example, if a WTRU receives an indication to transmit in SFN STxMP mode of operation, the WTRU may generate the UCI payload, and multiplex the same UCI payload on panel 1 and panel 2. Alternatively, the WTRU may receive an indication in a DCI to dynamically switch between UCI repetition and partitioning the payload over two panels.

A WTRU may be equipped with multiple panels where a UCI transmission is possible. If a WTRU determines to multiplex onto only one panel, the WTRU may use one or more of the following rules for panel selection. A rule for panel selection may comprise selecting the panel with the highest signal quality (e.g., RSRP, SINR). A rule for panel selection may comprise selecting the panel with a signal quality above a threshold delta. A rule for panel selection may comprise selecting the panel with the highest RSRP amongst the two panels. A rule for panel selection may be a function of an indication (e.g., dynamically in a DCI, or explicitly configured in a CG-PUSCH). For example, a WTRU may receive an explicit indication in a DCI such as a bitfield which may indicate the panel and associated beta value where the WTRU may multiplex the UCI. A rule for panel selection may comprise selecting the panel associated to the SRS resource set with the lowest set ID. A rule for panel selection may comprise selecting the panel associated to the SRS resource with the lowest ID. A rule for panel selection may comprise selecting the same panel where the PUSCH scheduling grant was received. For example, a WTRU may receive a DCI carried by a PDCCH on panel 1, and the WTRU may select panel 1 for multiplexing the UCI. The signal quality per panel may be determined based on a measurement with a reference signal sent or received by each panel.

A WTRU may determine UCI resource allocation per panel. For example, a WTRU may determine the beta factor (fraction of PUSCH resources allocated for UCI multiplexing) to apply in STxMP or on one of the panels. More than one set of beta factor/offset values may be configured, where each set is associated to a transmission mode (e.g., single panel or STxMP). A WTRU may use the beta factor/offset values associated with the determined transmission mode. For example, a WTRU may receive more than one beta factor value for a single panel. A WTRU may determine to use a first beta factor value for panel 1 if the UCI is multiplexed in single panel mode, or a WTRU may determine to use a second beta factor value for panel 1 if the UCI is multiplexed into STxMP.

A WTRU may receive one beta value per panel, and the WTRU may determine to multiplex the UCI on one of the panels based on one of the panel selection rules, and the WTRU may use the beta value associated with the determined panel. A WTRU may receive the beta values preconfigured per panel, or a WTRU may receive a grant where the beta values per panel are indicated. The WTRU may determine the association from a beta value to a panel based on a static allocation (e.g., first beta value for first panel, and second beta value for second panel), or based on a dynamic association (e.g., as a function of a DCI indication).

A WTRU may determine to use one beta value and an additional beta offset value. The WTRU may receive a preconfigured beta value, and the beta offset value may be dynamically indicated in a DCI, where the DCI indicates one offset value out of a set of preconfigured beta offset values. A WTRU may map the UCI onto the determined panel, and the WTRU may determine that the total ratio of resources for mapping the UCI includes the beta value plus the beta offset. The WTRU may receive more than one beta offset value in a DCI, where each beta offset may be associated with a panel. If a WTRU does not receive any beta offset value, a WTRU may apply a default value (e.g., 0) to the beta offset, and use the same preconfigured beta factor for both panels.

A WTRU may transmit the UCI on multiple (e.g., two) panels, where the WTRU may partition the UCI into respective multiple (e.g., two) parts, and the WTRU may multiplex each part onto one of the panels. A WTRU may receive two beta values, e.g., beta1 and beta2, where beta1+beta2=1. A WTRU may determine to send a fraction of beta1 of the UCI payload on panel 1, and a fraction beta2 of the UCI payload on panel 2.

If a WTRU is scheduled to transmit UCI in STxMP over two panels, but the WTRU cannot multiplex the UCI (e.g., due to insufficient power allocation in one panel, one panel deactivated, slot in one panel-TRP link not available for WTRU transmission, etc.), the WTRU may transmit a fallback indicator on a single panel to signal that the WTRU cannot transmit UCI in STxMP over the designated resources. The WTRU may dynamically receive in a DCI (e.g., PRI) or be preconfigured with resources and a fallback period of time T_fallback where the WTRU may transmit the fallback indicator. The WTRU may wait for a period of time T_fallback before transmitting the UCI in STxMP. The fallback resources may consist of PUCCH resources or an UL MAC-CE.

What is claimed is:

1.-15. (canceled)

16. A wireless transmit/receive unit (WTRU) comprising:
a transceiver; and
a processor configured to:
receive, via the transceiver, configuration information, the configuration information comprising an indication of a first physical uplink control channel (PUCCH) resource, a second PUCCH resource, and an association of one or more respective channel state information (CSI) content types to each of a first CSI part, a second CSI part, the first PUCCH resource, and the second PUCCH resource;
determine a CSI report comprising the first CSI part and the second CSI part, wherein the CSI report is based on the association of the one or more respective CSI content types to the first CSI part and the second CSI part;
transmit, via the transceiver, the first CSI part of the CSI report using the first PUCCH resource at a first time;
transmit, via the transceiver, a first portion of the second CSI part of the CSI report using the first PUCCH resource at a second time, wherein the second time is different than the first time; and
transmit, via the transceiver, a second portion of the second CSI part of the CSI report using the second PUCCH resource, wherein transmission of the second portion of the second CSI part of the CSI report overlaps in time with transmission of the first portion of the second CSI part of the CSI report.

17. The WTRU of claim 16, wherein the first CSI part and the second CSI part are further based on a measurement of one or more reference signals.

18. The WTRU of claim 16, wherein CSI content types of the first portion and the second portion of the second CSI part of the CSI report are based on the association of CSI content types to the first PUCCH resource and the second PUCCH resource.

19. The WTRU of claim 16, wherein at least one of the one or more CSI content types comprises information identifying whether to use a single panel of the WTRU or a multiple panels of the WTRU to determine the CSI report.

20. The WTRU of claim 16, wherein the processor is configured to:
transmit, via the transceiver, the first CSI part of the CSI report via a single panel of the WTRU; and
transmit, via the transceiver, the first portion and the second portion of the second CSI part of the CSI report via multiple panels of the WTRU.

21. The WTRU of claim 16, wherein the processor is further configured to prioritize transmission of the CSI report based on a number of transmission/reception points (TRPs).

22. The WTRU of claim 16, wherein the processor is further configured to prioritize transmission of the CSI report based on transmission power of the WTRU.

23. The WTRU of claim 16, wherein the processor is further configured to prioritize transmission of the CSI report based on overlap in time of PUCCH resources.

24. The WTRU of claim 16, wherein the processor is further configured to prioritize transmission of the CSI report based on overlap in frequency of PUCCH resources.

25. The WTRU of claim 16, wherein the configuration information comprises a transmission time offset parameter.

26. A method performed by a wireless transmit/receive unit (WTRU), the method comprising:
receiving configuration information, the configuration information comprising an indication of a first physical uplink control channel (PUCCH) resource, a second PUCCH resource, and an association of one or more respective channel state information (CSI) content types to each of a first CSI part, a second CSI part, the first PUCCH resource, and the second PUCCH resource;
determining a CSI report comprising the first CSI part and the second CSI part, wherein the CSI report is based on the association of the one or more respective CSI content types to the first CSI part and the second CSI part;
transmitting the first CSI part of the CSI report using the first PUCCH resource at a first time;
transmitting a first portion of the second CSI part of the CSI report using the first PUCCH resource at a second time, wherein the second time is different than the first time; and
transmitting a second portion of the second CSI part of the CSI report using the second PUCCH resource, wherein transmission of the second portion of the second CSI part of the CSI report overlaps in time with transmission of the first portion of the second CSI part of the CSI report.

27. The method of claim 26, wherein the first CSI part and the second CSI part are further based on a measurement of one or more reference signals.

28. The method of claim 26, wherein CSI content types of the first portion and the second portion of the second CSI part of the CSI report are based on the configured association of CSI content types to the first PUCCH resource and the second PUCCH resource.

29. The method of claim 26, wherein at least one of the one or more CSI content types comprises information identifying whether to use a single panel of the WTRU or a multiple panels of the WTRU when determining the CSI report.

30. The method of claim 26, further comprising:
transmitting the first CSI part via a single panel of the WTRU; and
transmitting the first portion and the second portion of the second CSI part via multiple panels of the WTRU.

31. The method of claim 26, further comprising prioritizing transmission of the CSI report based on a number of transmission/reception points (TRPs).

32. The method of claim 26, further comprising prioritizing transmission of the CSI report based on transmission power of the WTRU.

33. The method of claim 26, further comprising prioritizing transmission of the CSI report based on overlap in time of PUCCH resources.

34. The method of claim 26, further comprising prioritizing transmission of the CSI report based on overlap in frequency of PUCCH resources.

35. The method of claim 26, wherein the configuration information comprises a transmission time offset parameter.
